(19) United States
(12) Patent Application Publication
(10) Pub. No.: US 2025/0061868 A1
(43) Pub. Date: Feb. 20, 2025

(54) TUNING APPARATUS AND METHODS

(71) Applicant: Kristopher C. Barnett, Sebastian, FL (US)

(72) Inventor: Kristopher C. Barnett, Sebastian, FL (US)

(21) Appl. No.: 18/796,317

(22) Filed: Aug. 7, 2024

Related U.S. Application Data
(60) Provisional application No. 63/519,843, filed on Aug. 16, 2023.

(51) Int. Cl. G10D 3/14

(52) U.S. Cl. CPC G10D 3/14

(57) ABSTRACT

A tuning apparatus. A button and a first bracket and a second bracket. A worm gear operatively coupled to the button. The worm gear positioned between the first bracket and the second bracket. A spur gear enmeshed with the worm gear, such that rotating the worm gear rotates the spur gear about an axis perpendicular to the worm gear. A spring post operatively coupled to the spur gear such that rotating the spur gear rotates the string post about the axis perpendicular to the worm gear.

### PRIORITY CLAIM

This non-provisional patent application claims the benefit of U.S. Provisional Application No. 63/519,843 filed on Aug. 16, 2023, the entirety of which is incorporated herein by reference.

### FIELD

The present disclosure relates generally to tuning. More particularly, the present disclosure relates to a tuning apparatus and methods for tuning a stringed instrument, such as a guitar.

### BACKGROUND

A tuning apparatus, also known as a machine head or tuner, is an important component of stringed instruments like guitars. A primary function of these devices is to facilitate accurate and reliable tuning adjustments, allowing musicians to achieve a desired pitch for each string. Traditional guitar tuning devices have relied on mechanical systems that employ a spur gear and a worm gear mechanism to control string tension and pitch.

Certain conventional tuners consist of a worm gear attached to a tuning button or peg. The worm gear engages with a spur gear or cog, which, in turn, is connected to a string post. By turning the tuning button, the musician rotates the worm gear, causing the string to tighten or loosen, resulting in pitch adjustment.

While traditional guitar tuning machines have served their purpose, they are not without their limitations, particularly in regard to the bracket and worm configuration as well as the gear and string post assembly.

Certain conventional tuning machines employ a bracket, usually made of brass or steel, that is affixed to the baseplate. The bracket serves to hold the worm gear in place. Tuning machine manufacturers employ bushings, spacers, or washers made from a variety of plastic materials as an interface between the bracket and worm gear to improve performance. Although this configuration can function satisfactorily, there are several important limitations.

For example, the interaction between the worm gear and bracket bushing generates considerable friction during tuning operations. Such friction can impede smooth string winding or unwinding, affecting tuning stability and consistency.

In some cases, the absence of adequate support for the worm gear within the bracket assembly can result in structural instability. Insufficient load distribution or misalignment can also compromise the overall performance of the tuning apparatus.

Furthermore, continuous use can subject the worm and bracket assemblies to premature wear. Over time this can lead to stripped gears, loose connections, imprecise gear engagement, variations in the worm gear's alignment, and diminished durability. This can result in inconsistent pitch adjustments and a frustrating tuning process.

Conventional designs, where the worm and worm gear rotate on perpendicular axes, inherently produce significant axial loads on the brackets. While plastic bushings, washers, spacers, and radial bearings perform well under radial loads, they fail to adequately manage the substantial axial loads inherent in tuning apparatuses.

Traditional worm and bracket assemblies may require regular maintenance, such as lubrication and cleaning, to optimize their performance. The complexity of disassembling and reassembling these components, along with the need for specialized tools or expertise, can make maintenance cumbersome and time-consuming.

There is, therefore, a general need for guitar tuning devices that address certain limitations of traditional systems.

### SUMMARY

According to an exemplary arrangement, a tuning apparatus comprising a button; a first bracket and a second bracket; a worm gear operatively coupled to the button. The worm gear positioned between the first bracket and the second bracket. A spur gear enmeshed with the worm gear; such that rotating the worm gear rotates the spur gear about an axis perpendicular to the worm gear. A spring post operatively coupled to the spur gear such that rotating the spur gear rotates the string post about the axis perpendicular to the worm gear.

In one arrangement, the first bracket, the second bracket and the worm gear comprise an integrated bearing assembly.

In one arrangement, the tuning apparatus further comprising a first shaft that extends away from a first side of the worm gear.

In one arrangement, the first shaft extends through the first bracket.

In one arrangement, the first shaft extends through the second bracket.

In one arrangement, the tuning apparatus further comprising a second shaft that extends away from a second side of the worm gear.

In one arrangement, the second shaft extends through either the first bracket or the second bracket.

In one arrangement, the second shaft comprises a threaded shaft.

In one arrangement, the tuning apparatus further comprising an end pip in threaded engagement with the threaded shaft of the second shaft.

In one arrangement, the tuning apparatus further comprising a washer between the end pip and the first bracket or second bracket.

In one arrangement, the tuning apparatus further comprising a tuning apparatus base plate.

In one arrangement, the first bracket and the second bracket are affixed to a first side of the tuning machine base plate.

In one arrangement, the first bracket and the second bracket are rigidly affixed at right angles to the first side of the tuning machine base plate using a rivet, a screw, or other suitable means.

In one arrangement, an aperture defined by the bracket extends from the distal end of the bracket through to the recess of the bracket.

In one arrangement, an aperture defined by the base plate extends from the first surface to a second surface of the base plate.

In one arrangement, the apertures are coaxial.

In one arrangement, the string post extends through an aperture defined by the base plate.

In one arrangement, the tuning apparatus further comprising a fastener for attaching the worm shaft to the button.

In one arrangement, the fastener comprises a mechanical fastener.

In one arrangement, a drive assembly comprising a baseplate and a string post comprising a first end that extends through an aperture defined by the baseplate. A spur gear receiving the first end of the string post; and a first radial ball bearing residing between the string post and the baseplate.

In one arrangement, the string post comprises a non-circular distal end that is received in a recess defined by the spur gear.

In one arrangement, the drive assembly further comprising a flanged radial ball bearing interfacing between the spur gear and the base plate.

In one arrangement, the drive assembly further comprising a second radial ball bearing affixed to a second end of the string post.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is a perspective view of a tuning machine mounted to an instrument with a slotted headstock in accordance with some embodiments;

FIG. 2a is a perspective view of a tuning machine mounted to an instrument with a solid headstock in accordance with some embodiments;

FIG. 2b is a detailed perspective view of FIG. 2a from an oblique angle;

FIG. 3 is a perspective view of a tuning machine configured for a slotted headstock in accordance with some embodiments;

FIG. 4 is a perspective view of a tuning machine configured for a solid headstock in accordance with some embodiments;

FIG. 5 is a perspective view of a primary drive assembly in accordance with some embodiments;

FIG. 6 is an exploded view of a primary drive assembly in accordance with some embodiments;

FIG. 7 is an exploded view of a secondary drive assembly for slotted headstock in accordance with some embodiments; and

FIG. 8 is an exploded view of a secondary drive assembly for solid headstock in accordance with some embodiments.

FIG. 9 is a perspective view of a bracket assembly in accordance with some embodiments;

FIG. 10 is a cross-sectional view of a bracket assembly in accordance with some embodiments;

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present disclosure pertains to a design for guitar tuning devices and addresses certain limitations of traditional systems. In one preferred arrangement, an integrated thrust bearing worm assembly helps to ensure reduced friction, enhanced alignment of the worm and spur gear, and increased durability, leading to smoother and more accurate tuning adjustments. Additionally, in one arrangement, implementation of a radial ball bearing assembly in the string roller and spur gear eliminates slop and reduces friction at both the base plate and headstock, providing superior performance under various conditions. These advancements result in certain improvements such as enhanced longevity, lower maintenance requirements, and more reliable gear meshing, offering musicians a heightened tuning experience for their stringed instruments.

In one preferred arrangement, bracket and worm were designed as to not constrain the dimensions and sizes of the existing parts. For example, if off the shelf bearings were used, the shaft dimensions, recess dimensions, and other designed parameters would need to be a particular size which would limit the engineering possibilities. Also, classical aesthetics are very important, so the design has to be discreet.

In one preferred arrangement, the ball bearings are integrated into the bracket and worm to save weight and space. Additional parts (e.g., races and tracks) are not necessary. One advantage of such an integrated system is that it allows for a wider range of material options that are not feasible with conventional bearings.

In one preferred arrangement, the coaxial apertures defined by the base plate and the bracket are designed so that the ball bearings are lubricated from the rear surface of the base plate without needing to remove any components.

Integration allows for either loose ball bearings or caged ball bearings depending on the needs of the design. As just one example, the more ball bearings that are used, the larger the surface area and therefore less fatigue in the system.

In addition, the proposed design or designs are less expensive as precision ball bearings can be quite expensive.

Certain conventional tuning machine designs commonly utilize wave washers to facilitate the connection between the spur gear, string roller, and base plate. The assembly typically involves placing the wave washer either between the base plate and string roller or between the spur gear and base plate. The goal is to provide tension to the parts while still permitting their rotation. However, a drawback from such a configuration arises from the need to strike a balance between secure tightening and allowing free rotational movement.

Wave washers, being spring-like components, can introduce unwanted slop and play to the string roller. The presence of play can have an impact on the meshing of the worm and spur gear, potentially leading to undesirable consequences such as jamming or undue backlash. Additionally, any inaccuracies in the holes of the guitar's headstock can exacerbate these issues and cause premature wear and compromised performance.

Similarly, direct contact between the headstock and string posts can result in increased friction during tuning adjustments, leading to wear and potential damage over extended use. This excessive friction oftentimes negatively affects tuning stability, hampers smooth string winding or unwinding, and can introduce mechanical noise.

Furthermore, certain known designs often implement plastic bushings to eliminate unwanted metal-on-metal contact between the moving components. While plastic bushings may offer some initial cost advantages, they often generate drawbacks that can negatively impact the performance and longevity of the tuning machines such as limited durability, susceptibility to temperature changes, limited friction reduction, and deformation under pressure.

The presently disclosed tuning apparatus and methods address the challenges of traditional guitar tuning machines by implementing an integrated thrust bearing worm assembly and a radial bearing string roller assembly into the design.

The modified worm assembly offers reduced friction, more reliable gear meshing, improved load distribution, lower maintenance requirements, and enhanced durability. Similarly, the modified string roller assembly eliminates slop and reduces friction both at the plate and headstock ensuring quieter tuning operations, optimal performance under varying conditions, and improved overall functionality.

There are a number of benefits of utilizing and integrated thrust bearing assembly. A few of these benefits are summarized below.

Reduced Friction: Lower coefficient of friction compared to plastic bushings or washers allow for smoother and more efficient operation.

Improved Load Distribution: Distributes loads evenly across their surfaces thereby minimizing localized stress and wear.

Optimized Axial Load Handling: Integrated bearing assemblies are superior to radial bearings due to their optimized design for handling axial loads, ensuring smoother and more stable performance.

Enhanced Durability: Components constructed from steel for excellent resistance to wear, deformation, and degradation thereby extending lifespan.

Increased Precision: The smooth and precise movement enabled by bearings contributes to improved accuracy for finer control over string tension and pitch. Also allows for more accurate alignment of worm gear for optimized gear meshing.

Lower Maintenance: Due to their durability and reduced friction, bearings generally require less frequent maintenance compared to plastic bushings or washers. Their robust construction and efficient operation contribute to reduced wear and the need for replacement.

Easier to Manufacture and Assemble: The thrust bearing races are incorporated into the existing components thereby eliminating the need to install and manufacture additional parts.

Easier Lubrication: Allows for straightforward lubrication through holes in the back of the baseplate without the need for removal or disassembly of system components.

There are a number of benefits of utilizing the string roller and spur gear assembly as herein disclosed. A number of these benefits is summarized below.

Minimized Slop: Replacing wave washers with radial bearings eliminates unwanted play or slop in the string roller.

Reduced Friction: Radial bearings minimize friction between the string roller and baseplate and where the string post meets the headstock, minimizing wear on both the posts and the headstock. This can result in smoother, more accurate, and more efficient tuning operations.

Enhanced Durability: Radial bearings are constructed with robust materials, enhancing the tuning apparatus longevity and reducing the need for replacements.

Quieter Operation: The use of radial bearings reduces mechanical noise during tuning, providing a quieter and more enjoyable playing experience.

Optimal Performance in Various Conditions: Radial bearings offer resilience to temperature changes and variations in string tension, maintaining consistent performance under different environmental conditions.

Smoother Gear Meshing: Radial bearings facilitate precise alignment between the worm gear and bracket, ensuring smooth gear meshing and minimizing wear on components.

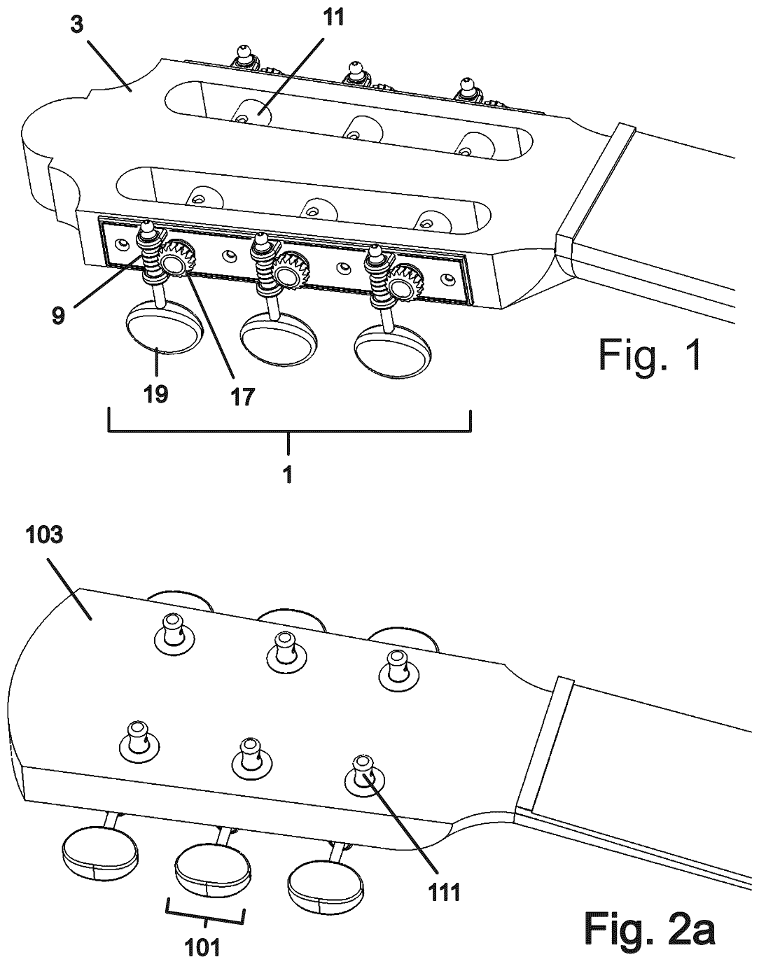

Referring now to FIG. 1, FIG. 1 of the drawings illustrates a tuning apparatus (1) mounted to an instrument with a slotted headstock (3). The user or player of the apparatus rotates a button (19) thereby rotating a worm gear (9) about a same axis. The worm gear (9) is enmeshed with a spur gear (17) such that rotating the worm gear (9) consequently rotates the spur gear (17) about a perpendicular axis relative to the worm gear (9). The spur gear (17) is rigidly affixed to a string post (11) such that rotating the spur gear (17) consequently rotates the string post (11) about a same axis.

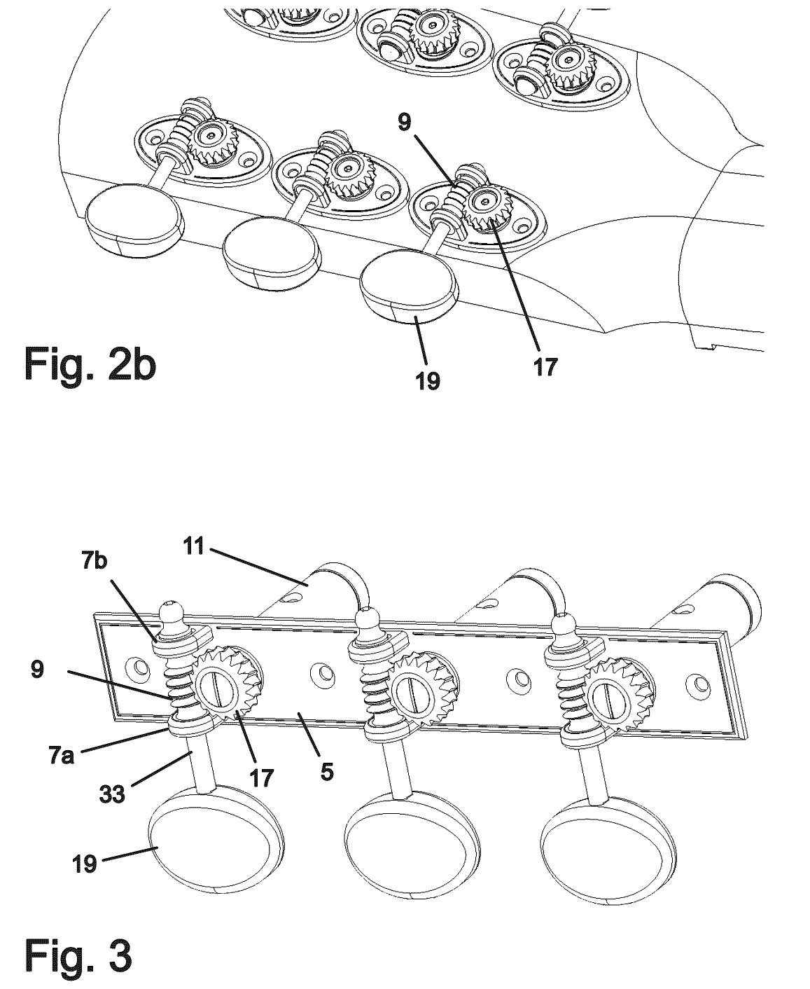

FIG. 2a of the drawings illustrates a tuning apparatus (101) mounted to an instrument with a solid headstock (103). FIG. 2b of the drawings illustrates a detailed view of the FIG. 2a from a reverse angle. Referring now to FIGS. 2a and 2b, the user or player of the tuning apparatus rotates a button (19) thereby rotating a worm gear (9) about a same axis. The worm gear (9) is enmeshed with a spur gear (17) such that rotating the worm gear (9) consequently rotates the spur gear (17) about a perpendicular axis relative to the worm gear (9). The spur gear (17) is rigidly affixed to a string post (111) such that rotating the spur gear (17) consequently rotates the string post (111) about a same axis.

FIG. 3 of the drawings illustrates a tuning apparatus (1) for a slotted headstock (3). A worm gear (9) is positioned between two brackets (7a and 7b) that are rigidly affixed at right angles to a first side of a tuning machine base plate (5) using rivets, screws, or other suitable means. In the preferred embodiment, the brackets (7a and 7b) and the worm gear (9) are made from chrome steel, although other suitable materials could be used. A button (19) is secured to a distal end of a worm shaft (33) and is shaped to allow a player to grip and rotate said button (19) which consequently rotates the worm gear (9). An adhesive or mechanical fastener rigidly attaches the worm shaft (33) and the button (19). The worm gear (9) interfaces a spur gear (17) in a conventional configuration such that rotating the worm gear (9) consequently rotates the spur gear (17) about a perpendicular axis relative to the worm gear (9). The spur gear (17) receives a string post (11) that extends through the base plate (5) from a second side.

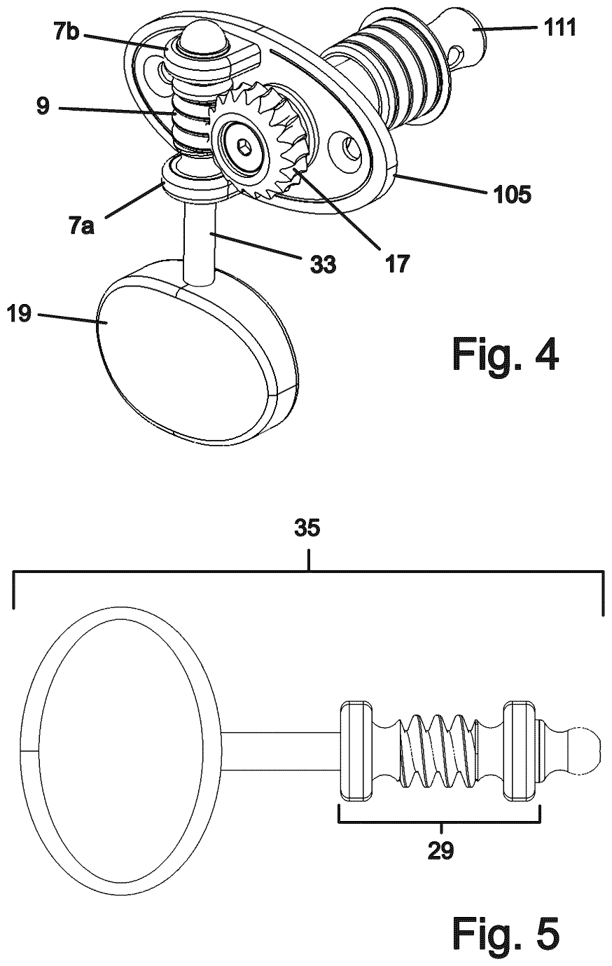

FIG. 4 of the drawings illustrates a tuning apparatus (101) for a solid headstock (103). A worm gear (9) is positioned between two brackets (7a and 7b) that are rigidly affixed at right angles to a first side of a tuning apparatus base plate (105) using rivets, screws, or other suitable means. In the preferred embodiment, the brackets (7a and 7b) and the worm gear (9) are made from chrome steel, although other suitable materials could be used. A button (19) is secured to a distal end of a worm shaft (33) and is shaped to allow a user or player to grip and rotate the button (19) which consequently rotates the worm gear (9). An adhesive or mechanical fastener rigidly attaches the worm shaft (33) and the button (19). The worm gear (9) interfaces a spur gear (17) in a conventional configuration such that rotating the worm gear (9) consequently rotates the spur gear (17) about a perpendicular axis relative to the worm gear (9). The spur gear (17) receives a string post (111) that extends through the base plate (5) from a second side.

FIG. 5 of the drawings illustrates a primary drive assembly (35) and an integrated thrust bearing bracket subassembly (29). The primary drive assembly is suitable for both slotted headstock (3) and solid headstock (103) instruments.

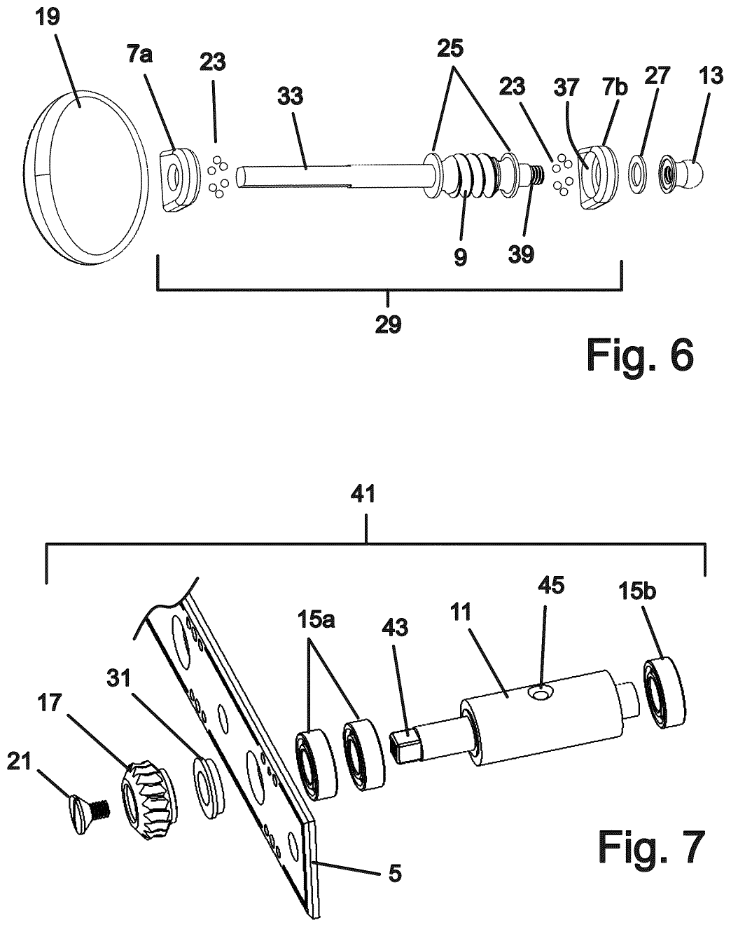

FIG. 6 of the drawings is an exploded view of a primary drive assembly (35) and integrated thrust bearing bracket subassembly (29). A worm gear (9) is positioned between two brackets (7a and 7b). In the preferred embodiment, the brackets (7a and 7b) and the worm gear (9) are made from chrome steel, although other suitable materials could be used. A shaft (33) extends away from a first side of the worm gear (9) and extends through the bracket (7a). A button (19) is secured to a distal end of the worm shaft (33) and is shaped to allow a player to easily grip and rotate said button (19) which consequently rotates the worm gear (9). An adhesive or mechanical fastener rigidly attaches the worm shaft (33) and the button (19). A recess (37) in a first side of the brackets (7a and 7b) accepts 2 or more ball bearings (23) and a flat surface (25) on a distal end of the worm gear (9) interfaces the ball bearings (23) on the opposing side. In a preferred embodiment, grooves in the worm gear (9) and the brackets (7) accept the ball bearings (23) and allow for more precise alignment of the worm gear (9) and the brackets (7a and 7b). A second shaft (39) extends away from a second side of the worm gear (9) and extends into a second bracket (7b). In the preferred embodiment, the second shaft (39) extends past the bracket (7b) and is threaded to accept an end pip (13). The end pip (13) can be tightened or loosened to adjust the amount of rotational force required to rotate the button (19). A washer (27) is positioned between the pip (13) and the bracket (7b) to reduce friction and can be made from suitable materials.

FIG. 7 of the drawings is an exploded view of a secondary drive assembly (41) for instruments with a slotted headstock (3). A spur gear (17) receives a string post (11) that extends through a base plate (5). In an embodiment, the string post (11) has a non-circular distal end (43) that is received in a corresponding recess in the spur gear (17) and can be friction fit or secured with an adhesive or mechanical fastener (21). A flanged radial ball bearing (31) interfaces the spur gear (17) and the base plate (5). At least one radial ball bearing (15a) interfaces the string post (11) and the base plate (5). The bearing (15a) reduces friction both between the string post (11) and the base plate (5) as well as between the string post (11) and the slotted headstock (3). A hole (45) in the string post (11) accepts a string such that rotating the string post (11) winds or unwinds the string, thereby increasing or decreasing its relative pitch. At least one radial ball bearing (15b) is affixed to a distal end of the string post (11) and decreases friction at the junction of the string post (11) and the slotted headstock (3).

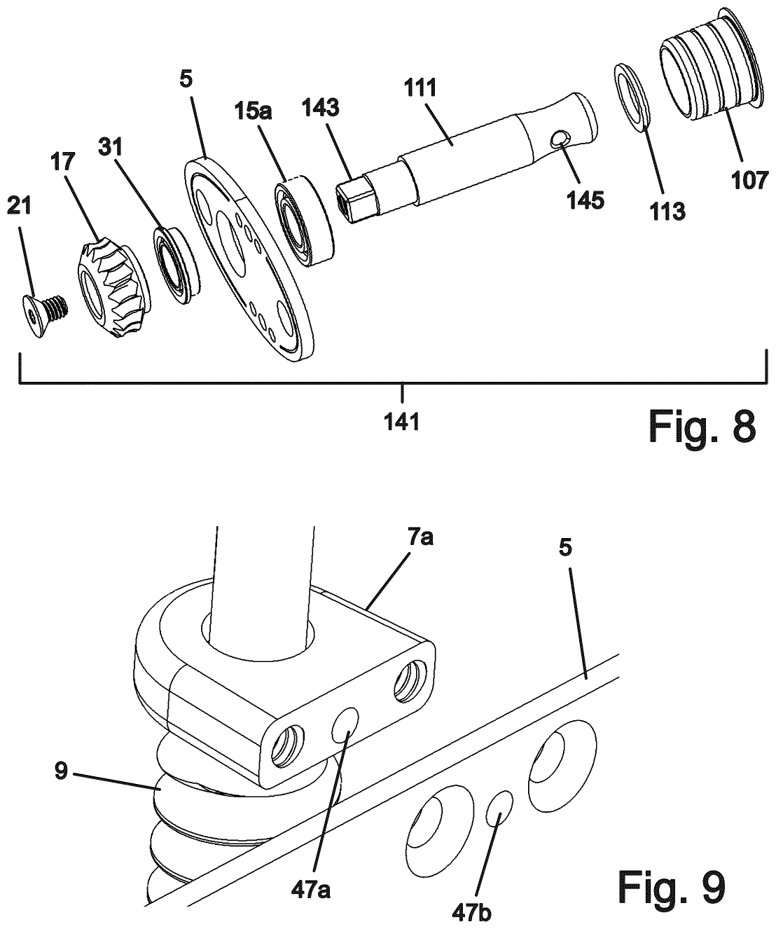

FIG. 8 of the drawings is an exploded view of a secondary drive assembly (141) for instruments with a solid headstock (103). A spur gear (17) receives a string post (111) that extends through a base plate (105). In the preferred embodiment, the string post (111) has a non-circular distal end (143) that is received in a corresponding recess in the spur gear (17) and can be friction fit or secured with an adhesive or mechanical fastener (21). A flanged radial ball bearing (31) interfaces the spur gear (17) and the base plate (5). At least one radial ball bearing (15a) interfaces the string post (111) and the base plate (5). A hole (145) in the string post (111) accepts a string such that rotating the string post (111) winds or unwinds the string, thereby increasing or decreasing its relative pitch. A string post bushing ring (113) is installed in a string post bushing (107) to prevent undue friction. The string post bushing (107) is fitted to a reverse side of the solid headstock (103).

FIG. 9 of the drawings is an exploded view of a bracket (7a), a base plate (5), and a worm gear (9). The bracket (7a) is rigidly affixed at a right angle to the base plate (5) such that an aperture (47a) defined by the bracket (7a) is coaxial with a second aperture (47b) defined by the base plate (5).

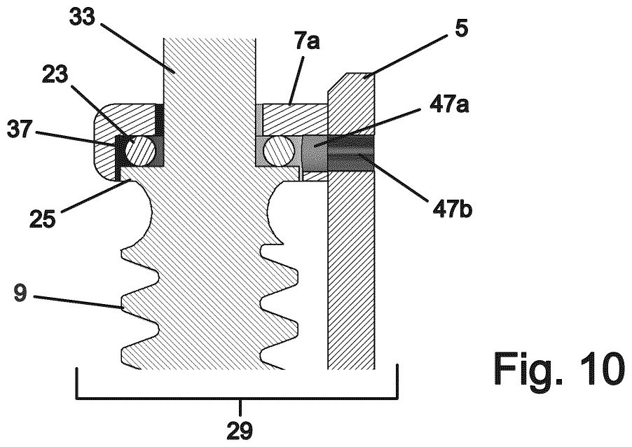

FIG. 10 of the drawings is a cross-sectional view of a portion of the integrated thrust bearing bracket subassembly (29). The worm gear (9) is proximate to the bracket (7a). The shaft (33) extends away from the worm gear (9) and extends through the bracket (7a). The recess (37) in the bracket (7a) accepts at least one ball bearing (23) and a surface (25) on the distal end of the worm gear (9) is configured to interface at least one ball bearing (23) on the opposing side. An aperture (47a) defined by the bracket (7a) extends from a distal end of the bracket (7a) to the recess (37) of the bracket (7a). An aperture (47b) in the base plate (5) extends from a first surface to a second surface of the base plate (5). In one preferred arrangement, the apertures (47a and 47b) are coaxial.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. A tuning apparatus comprising:
a button;
a worm gear operatively coupled to the button;
wherein the worm gear is positioned between a first bracket and a second bracket;
wherein the first bracket and the second bracket are configured to receive at least one ball bearing;
the worm gear is operatively coupled to the first bracket and the second bracket;
a spur gear enmeshed with the worm gear;
such that rotating the worm gear rotates the spur gear about an axis perpendicular to the worm gear; and
a string post operatively coupled to the spur gear;
such that rotating the spur gear rotates the string post about the axis perpendicular to the worm gear.

2. The tuning apparatus of claim 1 wherein the first bracket and/or the second bracket is configured to receive at least 1 ball bearing.

3. The tuning apparatus of claim 2 further comprising a first shaft that extends away from a first side of the worm gear.

4. The tuning apparatus of claim 3 wherein the first shaft extends through the first bracket.

5. The tuning apparatus of claim 3 wherein the first shaft extends through the second bracket.

6. The tuning apparatus of claim 3 further comprising a second shaft that extends away from a second side of the worm gear.

7. The tuning apparatus of claim 6 wherein the second shaft extends through either the first bracket or the second bracket.

8. The tuning apparatus of claim 6 wherein the second shaft comprises a threaded shaft.

9. The tuning apparatus of claim 8 further comprising an end pip in threaded engagement with the threaded shaft of the second shaft.

10. The tuning apparatus of claim 1 further comprising a washer between the end pip and the first bracket or the second bracket.

11. The tuning apparatus of claim 2 further comprising a tuning apparatus base plate.

12. The tuning apparatus of claim 11 wherein the first bracket and the second bracket are affixed to a first side of the tuning machine base plate.

13. The tuning apparatus of claim 12 wherein the first bracket and the second bracket are rigidly affixed at right angles to the first side of the tuning machine base plate using a rivet, a screw, or other suitable means.

14. The tuning apparatus of claim 11 wherein the string post extends through an aperture defined by the base plate.

15. The tuning apparatus of claim 1 further comprising a fastener for attaching the worm shaft to the button.

16. The tuning apparatus of claim 1 wherein the worm gear is configured to receive at least 1 ball bearing.

17. A drive assembly comprising
a baseplate;
a string post comprising a first end that extends through an aperture defined by the baseplate;
a spur gear receiving the first end of the string post; and
a first radial ball bearing residing between the string post and the baseplate.

18. The drive assembly of claim 17, wherein the string post comprises a non-circular distal end that is received in a recess defined by the spur gear.

19. The drive assembly of claim 17 further comprising a flanged radial ball bearing interfacing between the spur gear and the base plate.

20. The drive assembly of claim 17 further comprising a second radial ball bearing affixed to a second end of the string post.
